(19) United States
(12) Patent Application Publication
(10) Pub. No.: US 2010/0197323 A1
(43) Pub. Date: Aug. 5, 2010

(54) Proactive menu-driven links or triggers for location-based services and mobile advertising

(75) Inventors: James Freeburg, Naperville, IL (US); Mingshen Gao, Batavia, IL (US)

Correspondence Address: HARNESS, DICKEY & PIERCE, P.L.C., P.O. BOX 8910, RESTON, VA, 20195, US

(73) Assignee: Alcatel-Lucent Technologies Inc.

(21) Appl. No.: 12/320,826

(22) Filed: Feb. 5, 2009

(51) Int. Cl. H04W 4/02

(52) U.S. Cl. 455/456.2

(57) ABSTRACT

Example embodiments provides low-cost, effective methods of mobile advertising to mobile users. The methods provide both transmitting and receiving broadcast text-formatted, category-based data relating to services from local businesses and on-demand services, to capable mobile devices in a zone formed by network nodes, without user interaction. The data may be viewed as lists with menu-driven ‘contact-list’ type software, familiar to most mobile device users and configurable by nearly all types of mobile devices. The methods also notify a user of a mobile device when new events occur or service information is updated. Example embodiments use the broadcast-multicast capability of Radio Access Networks (RAN) to transmit to mobile devices served by sectors or cells in a localized zone (e.g., one or more cells that cover a shopping mall and nearby areas).

### BACKGROUND OF THE INVENTION

There are millions of applications and services offered on the World Wide Web (WWW) and tens of thousands of mobile users even in small areas covered by few telecommunications network cells/sectors. Also, location-based services (LBS) are available from local businesses that may be useful, of interest, and helpful to people that are on the move in or near the neighborhood of the businesses. An ongoing challenge is how to conveniently and economically connect these mobile users with the available WWW or LBS services. Just giving mobile users the ability of going ‘on-line’ and hoping they will be able to find a local business without further help has not worked well, as the penetration of data usage is still relatively low even though tens of millions of 3 G mobile devices with data capability have been sold. Often, mobile users may not have the Data service subscription (even with capable mobile phones) or simply forget to use their mobile device to get the necessary service or information that would help them.

For example, the environments are different between a mobile phone and personal computer. When searching on a computer, simple-to-use, well organized and formatted links pointing to various services are provided through a web interface using large screens, full-sized keyboards and constant high-speed broadband connections. Comparatively, mobile devices (e.g., phones, smart phones, PDAs, etc.) have small screens, limited input capabilities, and short affordable connectivity time with limited bandwidth. Therefore, many mobile users do not take full advantage of their mobile devices. In addition, many mobile users cannot take full advantage of a mobile service providers services because, for example, a mobile user does not have paid data services for internet access, or a mobile user's device does not include positioning (e.g., GPS) capabilities.

There are may more people who can access mobile phones than PCs at any given time and therefore a need exists for low-cost and effective methods to connect services on the internet or offered by local businesses to consumers with all kinds of mobiles.

### SUMMARY OF THE INVENTION

Example embodiments provide low-cost, effective methods of mobile advertising to mobile users. Example embodiments proactively download simple text-formatted, category-based lists of URL-like links that point to available services from local businesses to capable mobile devices in a zone formed by at least one network node without a user's interaction. The lists may be viewed by using menu-driven ‘contact-list’ type software, familiar to most mobile device users and configurable by nearly all types of mobile devices. Example embodiments may also proactively notify the mobile device's user when new events occur or service information is updated, where the new event or service information updating may be a special promotional announcement or newly available services.

Example embodiments use the broadcast-multicast capability of Radio Access Networks (RAN) to transmit localized or location based, category-classified lists of links for pointing to localized services and applications to mobile users served by a few sectors or cells in a localized zone (e.g., one or more cells that cover a shopping mall and nearby areas).

Example embodiments provide methods of transmitting location based service data, based on the location of at least one network node. The methods include broadcasting location based services (LBS) data from at least one network node to receivers in the zone of the network node. The zone may be based on at least a portion of a radio coverage area of the at least one network node, the LBS data being in a downloadable text format. The zone may also be based on at least a portion of radio coverage for each of a plurality of network nodes. The LBS data may be constructed as a list of location based service data, including at least one category of location based service data and individual location based service data. The LBS data may be displayed as a categorized list including menus and sub-menus, which may be updated periodically.

The categories of location based service data may include special event, shopping, sales, restaurant, travel, etc. The individual base service data may include text descriptions of location based services, including services offered locally based on the location of at least one network node and general on-demand services. Example embodiments further provide the text description including an advertisement, a promotion, an announcement, contact information, descriptions of services, travel information, URL addresses, active connection links, etc.

The location based services data may also be updated. Broadcast update location based services data may be transmitted to receivers, where the update location based services data includes an update to at least a portion of the broadcast location based services and new location based services data. The broadcast update location base services data may include a notification indicator and a flag having a value indicating the version of the data.

Example embodiments also provide methods of receiving transmitted location based services data at a receiver. The methods include receiving broadcast location based services data at a receiver based on the location of at least one transmitting network node. The methods also include storing the location based services data at the receiver, organizing the data into a list, and displaying the list on the receiver. The broadcast location based services data may also be updated when the receiver changes zones or the receiver receives a new update of the data.

### BRIEF DESCRIPTION OF THE DRAWINGS

Example embodiments will be more clearly understood from the following detailed description taken in conjunction with the accompanying drawings. FIGS. 1-4 represent non-limiting, example embodiments as described herein.

FIG. 1 illustrates a network according to an example embodiment;

FIGS. 2A-2C illustrate textual lists of location based services data as stored in a mobile device and as may be shown on a mobile user's device according to example embodiments;

FIG. 3 shows a data structure format used to organize the local categorized lists of services according to an example embodiment; and

FIG. 4 shows a data structure format to indicate updated service list information according to an example embodiment.

### DETAILED DESCRIPTION OF THE EMBODIMENTS

Various example embodiments will now be described more fully with reference to the accompanying drawings in which some example embodiments are illustrated. In the drawings, the thicknesses of layers and regions may be exaggerated for clarity.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, e.g., “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the present invention and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities.

Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

As used below the terms base station, base transceiver station (BTS), network node, NodeB, etc. are synonymous and may be used interchangeably to describe equipment that provides data connectivity between a wireless network and one or more UEs. Additionally where used below, the terms user, user equipment (UE), subscriber, mobile station, mobile device, wireless device, mobile user, mobile phone, remote station, receiver, etc. are synonymous and may be used interchangeably to describe a remote user of wireless resources in a wireless communication network.

Also, where used below, the term location based services (LBS), may include various types of services offered by local businesses to customers, e.g., information as to type of business, special offers, discounts, events, etc. The local businesses may include, e.g., food establishments, retail, wholesale, travel, cleaners, concierge, etc. In addition to traditional location based services, other types of non-specific location based services are intended to also be included in the term LBS as used throughout this description. For example, LBS may also include, on-demand services (e.g., special notices, news, sports, etc.), real-time streaming services, etc. that are independent of a specific location.

Mobile advertising for location based services has suffered from being considered “annoying spam” when a mobile user is not interested in the specific service being advertised because the advertised service lacks a relevant context at a right time in a right place. For example, sending a coupon for a restaurant to mobile users is not productive unless the restaurant can establish that the mobile users are looking for a place to eat.

Example embodiments allow local businesses to target all shoppers within a determined area, but on the shoppers' schedule and interests. For example, local businesses may contract with a service provider (e.g., wireless carrier) to include information (e.g., address, phone number, coupon, specials, etc.) in a broadcast from cells within a certain area, e.g., within 1 mile of a contracting business, to all mobile users serviced by the cells in the certain area. The broadcast download and subsequent update of the location based services data may be performed in the background. For example, a mobile user does not have to perform any action for the download of the location based services to occur on the user's mobile device and a user may view a list of the location based services at their convenience.

Example embodiments may include using Radio Access Network (RAN) broadcasts to transmit location information as compared to advanced mobile device capabilities, for example, Global Positioning Systems (GPS) or Wi-Fi Positioning Systems. In addition, example embodiments may not need subscription based services (e.g., paid data service, short message services (SMS), etc., as no data connection is needed to receive the broadcast location based services data.

In addition, since broadcasting can download service data to essentially all the mobile phones in an area covered by a sector or a cell, significantly fewer air interface resources are used (e.g., EVDO RAN may be limited by its air interface capability in the reverse direction which is consumed for every connection) than with the traditional way of providing services, for example, by loading a web portal home page containing exactly the same data on a separate connection to each mobile device. Further, links provided this way are much more ‘alive’ than normal static links, as not only may the link be changed from place to place automatically to reflect service location changes due to users mobility, but also all the mobile users can be notified simultaneously of special events. For example, addresses and phone numbers could be automatically changed for a chain of stores and emphasis text strings can be updated to announce special events such as promotions.

Further, example embodiments may increase a service provider's access to “long tail” markets, where lots of opportunities exist for selling various small popular revenue services that collectively total an increase in revenue as compared to the few less popular large revenue services.

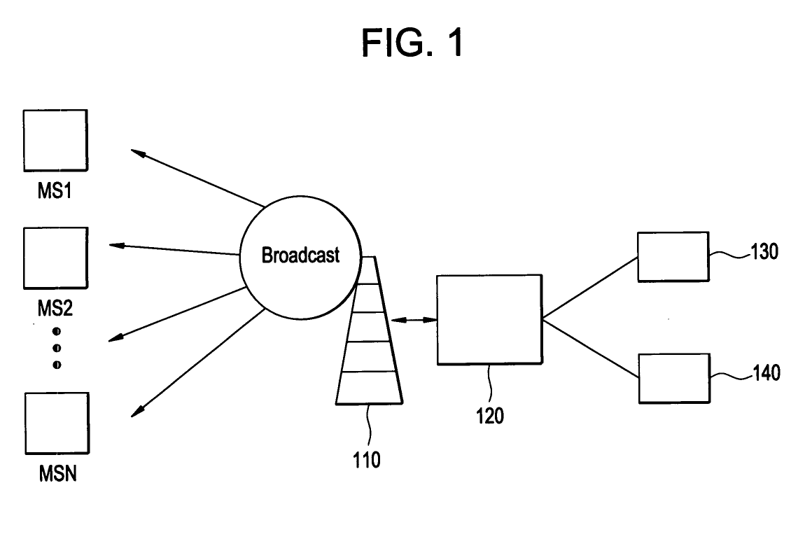

As shown in FIG. 1, a base transceiver station (BTS) 110 broadcasts to a plurality of mobile stations MS1 to MSn. The BTS 110 uses a broadcast method, for example, Broadcast Multicast Service (BCMCS) technology in CDMA/EVDO based mobile networks (see, e.g., 3 GPP2 C.S0054 ver. 1.0, Feb. 13, 2006, which is hereby incorporated by reference in its entirety), to broadcast location based services data to all mobile stations MS1 to MSn served by BTS 110. The location based services may be formatted as a data block including fields, etc. MS1 to MSn receiving the broadcast location based services data have the capability to download and display such data as, for example, a categorized list including menus and sub-menus, etc.

As noted above, example embodiments may be used in 3 G networks, e.g., CDMA/EVDO, UMTS, etc. However, one of ordinary skill in the art would understand that other networks, including 2 G, 2.5 G, and 4 G (e.g., Long Term Evolution (LTE), Ultra Mobile Broadband (UMB), etc.) may also be used.

The services included in the location based services data may be stored on servers 130 and 140. Servers 130 and/or 140 may include, for example, a Service Delivery Platform (SDP), IP Multimedia Subsystem Application Server (IMS AS), or local business servers that provide the local web-based services, which construct the location based services data and transmits the location based services data to Radio Access Network (RAN) 120 that may include Radio Network Controller (RNC), Packet Data Serving Node (PDSN) and Broadcast Service Node (BSN) network entities (not shown in detail).

Example embodiments may follow the network standard defined for the BCMCS technology in CDMA/EV-DO. However, since the example embodiments relate to location based services and the SDP servers 130 and 140 may act as BCMCS servers and content servers, some network elements such as a Broadcast Servicing Node (BSN) as well as the actual BCMCS controller and content servers may not be needed. The BSN functionality may also be embedded in the RNC. The services may be delivered in a variety of ways (e.g., internet/web with multimedia capability, voice, etc.) and by a variety of platforms or formats (e.g., IP Multimedia Subsystem (IMS) with Session Initiation Protocol (SIP) signaling capability, provisioned IP, etc.).

The RAN 120 through BTS 110 broadcasts the location based services data over the air interface to MS1 to MSn using BCMCS. The mobile stations MS1 to MSn may receive the location based services data from a broadcasting channel without the signaling exchange normally required to set up a connection to the RAN 120. The location based services data is broadcast in downloadable text format and may be downloaded automatically without the mobile stations MS1 to MSn or the mobile users' intervention. The downloaded location based services data may be saved/cached in the mobile device and may be displayed as a text based categorized list including menus and sub-menus.

To view the available location based services data, a mobile user may select an associated program capable of displaying the location based services data as a text based list. Some of the list may include text, for example, emphasis promotional announcement text strings with contact information (e.g., address, phone number, etc.) to achieve a mobile advertising effect. However, some lists may need additional connection to a data service. To initiate a data connection with RNC 120, mobile user MSn performs an action while viewing the list, e.g., clicking on a portion of text, which, for example, may be a URL address that leads to a web site, a telephone number that leads to a phone call to the service, etc.

Example embodiments may define a BCMCS program with associated BCMCS flows for broadcasting the services data in the 3 GPP2 standard format for BCMCSflowID with the following bits list:

111p,pppp,pppp,pppp,pppp,pppp,puff,ffff (1)

As described, a 32-bit format is used, but one of skill in the art would understand that the BCMCSflowID may be of various standard formats, e.g., a 16-bit format, etc.

In the above format, the first three “1” bits indicate the size of the discriminator for the BCMCS program. The 6 ‘f’ bits and the 1 ‘u’ bit indicate the BCMCS program discriminator. The ‘p’ bits (22 bits for this 32-bit BCMCSflowID format) indicate the BCMCS program and are provisioned by the network service operator (e.g., a wireless service provider) to identify the specific BCMCS program and distinguish the specified BCMCS program from other BCMCS programs in the system. The ‘u’ bit is optional and will be discussed below.

The six ‘f’ bits define up to 64 possible BCMCS flows for the BCMCS program and each combination of ‘f’ bits is used to identify an individual BCMCS flow. At each location (e.g., the minimum area covered by a single sector), only one BCMCS flow may be needed for broadcasting the localized location based services data for all the services available to the location that may belong to different zones, however one of ordinary skill in the art would understand that a cell or sector may be assigned to serve multiple zones. However, at times, nearby sectors for a specific coverage area (e.g., one or more sectors define a coverage area) may help broadcast the same content to increase the data rate if “soft-combine” technology for BCMCS in CDMA/EV-DO is used. In “soft-combine” technology, more than one transmission from multiple nearby sectors for the same BCMCS flow could be received by a mobile device and signals from the multiple transmission may be combined by the mobile device to achieve higher data rate reception. As such, multiple BCMCS flows may be transmitted by a sector (note, the available flows carried by a sector are indicated by the network in the BroadcastOverHead Message (BOM)), so a mobile device may be able to tune and receive the desired localized broadcast.

The broadcast location based services data (e.g., the broadcast data blocks defined in the next subsection) may be transmitted periodically, for example, every few minutes. By periodically broadcasting the location based services data, decreased amounts of system resources are used and mobile users who are new to a local coverage area would also receive current location based services data sooner. In addition, updates for the location based services data may also be broadcast periodically, e.g., on the same or a different schedule as the location based services data. Updates may also be broadcast on an as needed basis, e.g., when there is a change in a local service, etc.

To indicate an update, the optional u’ bit may be used. If the location based services data is being broadcast only when a portion of the location based services data is updated, then the u’ bit may be used to “force” the mobile devices to update the location based services data. When the ‘u’ bit is zero, the mobile device may ignore the same broadcasting BCMCS flow once the mobile device receives the location based services data and if the mobile device is still in the same coverage area that has the same location based services data as indicated by the version number in the header as discussed later. However, when the ‘u’ bit is set to one, the mobile device may update the location based services data. The update may include, for example, new services or be adjusted for services that have been removed. This feature may also be used for broadcasting special promotional announcements.

Additionally, a mobile user moving from cell to cell or sector to sector may automatically load new location based services data reflecting the actual availability of the corresponding localized services in the new area (zone) covered by the new cells or sectors. This zone crossing service data download may be triggered by missing a BCMCSFlowID from the BCMCSOverHead Message (BOM) due to a zone change if, for example, soft-combine technology is used, or triggered by a change in the cell/sector or version number in the broadcasting service data header if soft-combine technology is not used.

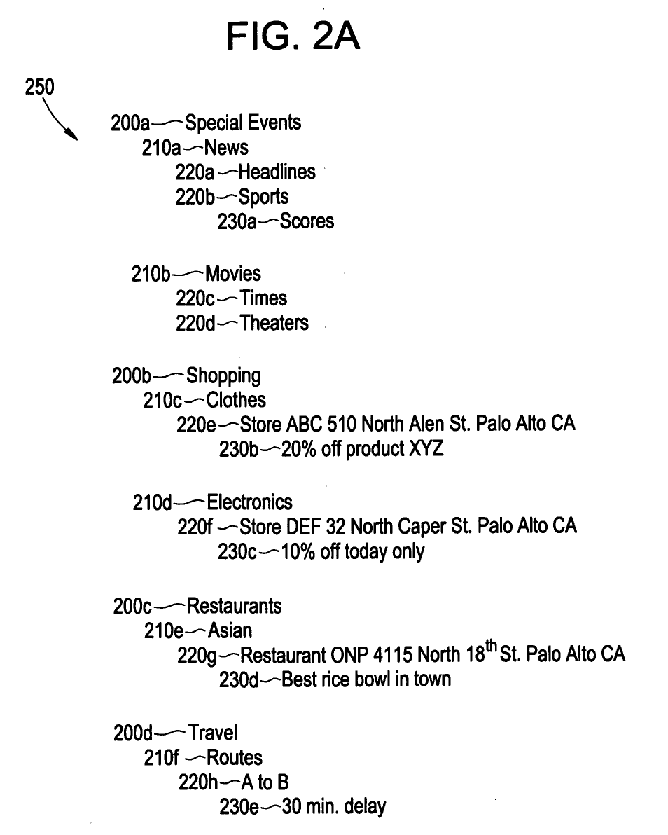

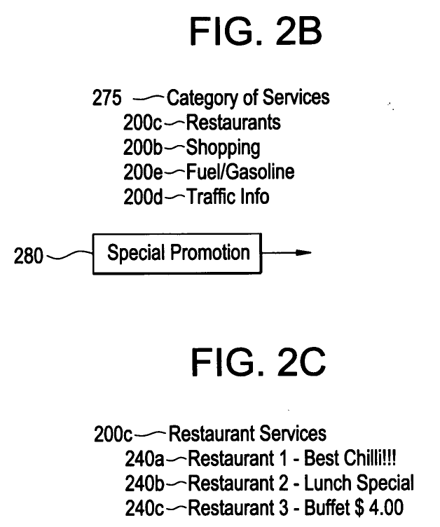

FIGS. 2A-C show screen shots of the broadcast location based services data according to example embodiments. In FIG. 2A, the location based services data is shown as a categorized text based list 250 including menus and sub-menus. The list 250 includes four categories, although the list may have any number of categories, including Special Events 200ₐ, Shopping 200_{b}, Restaurants 200_{c}, and Travel 200_{d}. Each category may also have sub-categories, which are displayed in a hierarchical menu format. In FIG. 2A, category Special Events 200ₐ includes sub-category/sub-menu News 210ₐ, which further includes sub-categories/sub-menus Headlines 220ₐ and Sports 220_{b}. In addition, Sports 220_{b} includes a sub-category/sub-menu Scores 230ₐ.

As shown in FIG. 2A, the Shopping 200_{b} category includes sub-categories/sub-menus Clothes 210_{c} and Electronics 210_{d} and these categories include Store ABC 220ₑ and DEF 220_{f}, respectively, each including an address. In addition, each store 220ₑ and 220_{f} are advertising discounts, 230_{b} and 230_{c}, respectively. Similarly, Restaurants 200_{c} and Travel 200_{d} include sub-categories Asian 210ₑ and Routes 210_{f}, respectively. Under Asian 210ₑ there is a Restaurant ONP (including an address) 220_{g} and Restaurant ONP 220_{g} is advertising the “Best rice bowl in town.” Under Routes 210_{f} is an identified route A to B 220ₕ, which then shows a 30 minute delay 230ₑ due to, e.g., an accident. Rerouting options, for example, ‘click to reroute’ may be added to data capable mobile devices as an additional option to get rerouting guidance.

FIGS. 2B-2C illustrate two separate screen shots, which are related. In FIG. 2B, the title “Category of Services” 275 further includes the various available services to a user, for example, Restaurants 200_{c}, Shopping 200_{b}, Fuel/Gasoline 200ₑ, and Traffic Info 200_{d}. FIG. 2C shows a screen shot a user may view if, for example, Restaurants 200_{c} had been selected from FIG. 2B. In FIG. 2C, the title “Restaurant Services” 200_{c} further includes three Restaurants 240ₐ-240_{c}, including their specials at the moment.

As discussed above, to avoid the difficulties and complexities of performing a mobile search, using for example, a mobile phone, example embodiments allow the software on a mobile device to reuse mechanisms familiar to mobile users, e.g., making a phone call using organized and displayed list of contact names, navigating a list with up and down arrow keys, selecting a function by entering with the ‘OK’ key, etc.

Example embodiments allow mobile users to access the broadcast location based services data by selecting a service associated with the location based services data from, e.g., one of the standard menus on the handset, which may display the services as a list of links as shown in FIGS. 2A-2C. Many variations for displaying and selecting the services are contemplated. For example, in addition to the categorized list shown in FIG. 2A, text associated with, e.g., headline news, sports scores, notifications of events, special promotions, etc. may continuously scroll across the bottom of a mobile device's display as shown in FIG. 2B. In addition, color, highlighting of categories, sound, etc., may also be used.

The displayed list may include Uniform Resource Locators (URL), where further data connection may be initiated when the link is activated, or URL-like links that include contact information and/or text for giving directions (e.g. text indicating the name of a business and an address, a phone number, emphasis text for specific promotions, etc.), to achieve an advertising effect from available and/or contracted local businesses. The data related to the displayed links are packed and broadcast in a predefined local area covered by one or more cell sectors as discussed below. The links may be embedded as hypertext links on a browser-capable mobile device's display with each link containing a protocol prefix, port number, domain name, subdirectory names and file name. However, a portion of the links may have a more general form, for example, a link may be used to trigger a connection to a specific server, similar to a URL in a web-browser, but a mobile user does not need a mobile device with data connection capabilities, as the link may be, for example, a phone number instead of a URL. For example, when a link corresponding to a phone number is chosen and/or activated, the mobile device may display “calling 123-456-7890, [ok?]” leading to a phone call to the service/business corresponding to the link. Example embodiments may include text based link as shown in FIG. 2.

Example embodiments may also include text based emphasis in the form of, for example, messages or descriptions of offers, promotions, sales, etc., which may be individually updated. For example, these text based emphasis messages may be sent to mobile phones at times when a business offers specials and/or promotions, to increase the advertising capability of the described service. These further described links enable retailers to target nearby shoppers having mobile devices, who may be in a buy-mode and/or are looking for special offers. When a mobile user refers to the displayed list, the mobile user may review the various links and click on any links of interest.

The text messages allow a local service to pass out key sales points to local potential customers in a timely manner, thus increasing the advertising effect. In addition, as there is no need for the mobile device to include specialized capabilities, the service decreases the burden on the network and may be generally made available. A mobile user's identity, preference selections, physical location, etc. may be used to determine which links to display on the mobile user's device. A link's history, (e.g., changed due to a new promotion) and/or other factors may also be used to order the list and determine categories.

FIGS. 2A-2C also include displayed text based links including various location based services and other on-demand and/or real time services as discussed above. For example, restaurants, shopping, special events, e.g., sports scores from NBA, NFL, NHL, etc., headline news, movie times, etc., local events, travel information, etc.

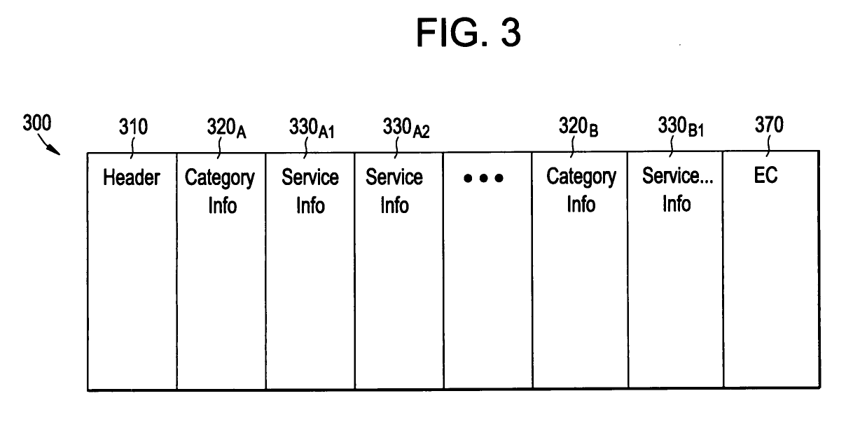

FIG. 3 shows an example embodiment of a broadcast data block 300, which may be used to broadcast the location-based services data to mobile users in a specific area. The broadcast data block 300, includes a header 310, category information fields 320_{A}, 320_{B}, service information fields 330_{A1}, 330_{A2}, and 330_{B1}, and error checking flag 370.

The header 310 indicates broadcast data block 300 includes a full category based list of services. The header 310 may also show the number of categories contained in the broadcast data block 300 and include a version number indicating the current version of the broadcast data block 300, where the version number changes when information for any one of the services changes.

The category information fields 320_{A}, 320_{B} include category identification (e.g., category IDs may be defined and used to reduce the size of the data transmitted), the number of services/links in the category, and a list of beginning offsets for the information associated with each service/link (e.g., an offset points to the correct “service information field” 330_{A1}, 330_{A2}, 330_{B1} for the service/link following the “category information field”) in the category. The category information fields 320_{A}, 320_{B} are data fields indicating a category of location based services.

The service information fields 330_{A1}, 330_{A2}, 330_{B1} include text descriptions for each service/link, which may include a protocol prefix, a port number, a domain name, subdirectory names, a file name, emphasis text messages, etc. The text descriptions may also include advertisements, promotions, announcements, contact information, information links, etc. The contact information may include, e.g., telephone numbers, email addresses, facsimile numbers, physical locations/addresses, information links (e.g., URL addresses), etc. One of ordinary skill in the art would recognize that the number of category information fields and service information fields may vary.

Finally, control flags for the service/link may also be included. For example, a control flag may indicate whether information associated with the service has changed. The control flags may be grouped with the offset field for each link in the “category information field” 320_{A}, 320_{B} so the total size for the entire broadcast data field 300 decreases. The error checking flag 370 is optional and may be, for example, a checksum.

The mobile device may be configured to display a portion of the service categories and cache related information. In addition, indications, for example, of the complexity and compatibility of each service with different types of mobile devices may be included in the service information fields 330_{A1}, 330_{A2}, 330_{B1}. For example, a displayed link may lead to a server having advanced video and graphical interactive requirements, which may only be used by advanced mobile devices. Each mobile device may determine whether the mobile device is capable of using each service based on, for example, software version, compatibility, etc. Alternatively, a mobile device may display text messages for services, but not connect to actual servers when a service is selected in view of the mobile device's capabilities.

In addition to a full category list of services, the broadcast data may be updated automatically, including network initiated proactive update notifications to be broadcasted to the mobile devices. By automatically updating the broadcast services data, the success of notifying thousands of mobile devices within a coverage area regarding events and special promotions from local businesses increases. For example, a mobile user in a shopping mall may be notified of promotions, e.g., special discounts, special coupons, etc., for items from a store or similarly, near or during lunch time, a restaurant may want to notify shoppers in the mall on some special offers, etc.

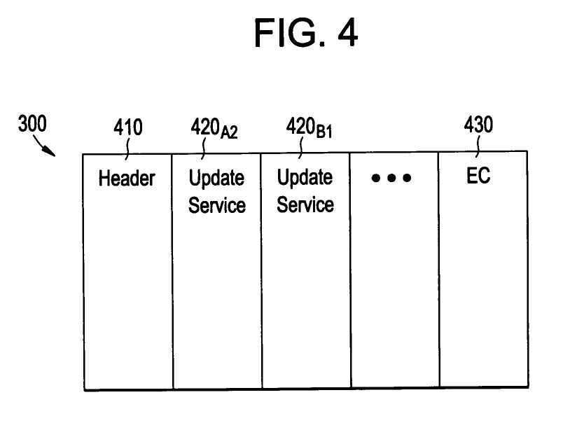

As shown in FIG. 4, example embodiments include update broadcast data blocks 400, including a header 410, updated service information fields 420_{A2}, 420_{B1}, and error checking flag 430. The header 410 indicates that the broadcast data block 400 is an update data block 400 and the services that have changed. The header 410 may also include a list for each of the changed services in the updating notification broadcast data block 400 and point to corresponding updated service information fields 420_{A2}, 420_{B1}. For each updated link, the header 410 may further include category information (e.g., category ID) and control flags to enforce the use of the same format for the service information fields discussed above. As described above, one of ordinary skill in the art would recognize that the number of service information fields may vary.

A mobile device will update the broadcast services, for example, when the version number in the header of a broadcast data block 300 is different than the version number stored in the mobile device for a previously received broadcast. When the version number has changed, the cached copy of services is replaced with the new received services. Alternatively, if the version number is the same, no change is made and the mobile device may ignore the received data or stop receiving the data after the header. In addition, if the mobile device is configured to receive update notifications, for example, through a control flag in the broadcast data field, then when the list is updated, the mobile device may also display a notification. For example, if a notification feature is enabled, a beep, sound, ring, tone, vibration, text-based link color change, icon, flashing text, etc. may be used to notify a mobile device user of the update.

Updated service information fields may be the same as the service information fields discussed above. By using the same format for the service information fields, updated service information may overwrite the cached information based on the control flags set for each service carried in the header. Similar to above, there may be an optional error checking flag (e.g., a checksum).

Example embodiments also have the broadcast data blocks 300 and 400 including non-location based services, for example, sports and news headlines as discussed above. For example, NBA scores may be treated as a service, which does not point to a server or specific business location, but includes the displayed scores (e.g., as set by preferences). These types of services may be updated and viewed by a mobile user at any time; and may be displayed as part of the displayed list or e.g., scrolled across an edge of the mobile device's display, e.g., when the phone's screen is activated (lit up).

Example embodiments may be offered to mobile users free by service providers, by charging each local business for the ability to locally advertise as described. Further, compared with known subscription-based plans, a service provider may offer a much broader range of generalized services from local businesses, while the service provider is paid. Payment by the local businesses may be determined by a base rate plus the number of clicks or various other accounting mechanisms.

The invention being thus described, it will be obvious that the same may be varied in many ways. Such variations are not to be regarded as a departure from the invention, and all such modifications are intended to be included within the scope of the invention.

We claim:

1. A method of transmitting location based services data, based on the location of at least one network node comprising:
broadcasting location based services data from the at least one network node to receivers in at least one zone of the at least one network node, the at least one zone being based on at least a portion of a radio coverage area of the at least one network node, the location based services data being in a downloadable text format.

2. The method of claim 1, wherein the broadcasting of location bases services data to receivers in the at least one zone is from a plurality of network nodes, the at least one zone including at least a portion of the radio coverage area of the plurality of network nodes.

3. The method of claim 2, wherein the at least one zone includes as least a portion of overlapping zones.

4. The method of claim 1, further including:
constructing a list of the location based services data, including at least one of a category of location based service data and individual location based service data.

5. The method of claim 4, wherein the category of location based service data includes at least one category of, special events, shopping, sales, restaurants, and travel.

6. The method of claim 4, wherein the individual based service data includes at least one text description of the individual location based service, the individual location based service data including at least one service offered locally based on the location of the at least one network node and a general on-demand service.

7. The method of claim 6, wherein the text description includes at least one of, an advertisement, a promotion, an announcement, contact information, description of a general on-demand service, travel information, a URL address, and an active connection link.

8. The method of claim 7, wherein the contact information, includes at least one of, a telephone number, an email address, a facsimile number, a physical address, and text directions to a physical address.

9. The method of claim 1, further including:
automatically broadcasting the location based services data to the receivers without a user of a receiver intervening.

10. The method of claim 1, further comprising:
broadcasting update location based services data to the receivers, the update location based services data including at least one of a portion of the broadcast location based services data and new location based services data.

11. The method of claim 10, the broadcasting update location based services data further including:
attaching at least one notification indicator to at least a portion of the broadcast update location based services data, wherein the presence of the notification indicator indicates to the receivers to notify the users of the receivers of the at least a portion of the broadcast update location based services data.

12. The method of claim 11, wherein the at least a portion of the broadcast update location based services data includes at least one of special promotions and services.

13. The method of claim 10, the broadcasting update location based services data further including:
inserting at least one flag in the broadcast update location based services data, wherein the at least one flag has a value indicating to the receivers the version of the broadcast update location based services data.

14. A method of receiving transmitted location based services data at a receiver, comprising:
receiving broadcast location based services data at a receiver based on the location of at least one transmitting network node, the receiver being located in at least one zone of the at least one network node, the at least one zone being based on at least a portion of a radio coverage area of the at least one network node, and the location based services data being in a downloadable text format.

15. The method of claim 14, further comprising:
storing the location based services data at the receiver;
organizing the location based services data into a list; and
displaying the list of broadcast location based services data as a categorized list including menus and sub-menus on the receiver.

16. The method of claim 15, further comprising:
receiving an update to the stored location based services data at the receiver without intervention from a user of the receiver, the update to the location based services data including at least one of a portion of the previously received broadcast location based services data and new location based services data.

17. The method of claim 16, further comprising:
notifying a user of the receiver of at least a portion of the updated location based services data.

18. The method of claim 16, wherein the receiver updates the stored location based services data when at least one of the following events occurs, the location of the receiver changes zones, a data version indication is received, a content changing indication is received, and the receiver receives a new update to the stored location based services data.

19. The method of claim 14, wherein the receivers include at least one of, a mobile phone, a wireless access card, a PDA, a Smartphone, and a portable computer.

20. The method of 16, wherein the receiver monitors broadcasts from the at least one transmitting node periodically.
